(19) United States
(12) Patent Application Publication
(10) Pub. No.: US 2025/0258993 A1
(43) Pub. Date: Aug. 14, 2025

(54) SYSTEMS AND METHODS FOR GENERATING TRACEABLE DOCUMENTS

(71) Applicant: Capital One Services, LLC, McLean, VA (US)

(72) Inventors: Matthew Louis NOWAK, Midlothian, VA (US); Michael Anthony YOUNG, JR., Henrico, VA (US); Christopher McDANIEL, Glen Allen, VA (US)

(21) Appl. No.: 18/440,303

(22) Filed: Feb. 13, 2024

(51) Int. Cl. G06F 40/166; G06F 40/103

(52) U.S. Cl. CPC G06F 40/166; G06F 40/103

(57) ABSTRACT

The invention relates generally to systems and methods for tracking a document by generating document variables, creating multiple new documents with different variables, and sending those new documents to different recipients. The document itself and the source of the document can be verified when a security leak occurs.

### FIELD OF THE DISCLOSURE

The present disclosure relates to system and methods for generating traceable documents.

### BACKGROUND

Sharing sensitive information is necessary for many businesses, however, sensitive information must be safeguarded against unauthorized disclosure. Breaches of security over such sensitive information often occur, including both inadvertent disclosure and malicious disclosure (e.g., hacking and data theft). It can be difficult to track where and how these breaches happen, particularly in the case of malicious disclosure, where a hacker or thief will attempt to conceal their identity and activities.

In some circumstances, metadata can indicate document ownership and transmission, but metadata can be removed easily with widely available software such as Microsoft Word® and Outlook® and as well as by software that is specialized for metadata removal. Thus, it is difficult to trace document breaches through conventional software.

These and other deficiencies exist. Accordingly, there is a need to provide systems and methods that overcome these deficiencies.

### SUMMARY OF THE DISCLOSURE

Aspects of the disclosed embodiments include systems and methods for generating traceable documents.

In some aspects, the techniques described herein relate to a system for identifying the source of document leaks, the system including: a processor configured to: receive a document; identify one or more changeable areas in the document; generate, by a predictive model, one or more document variables wherein the document variable include at least one or more changes in the document in the changeable areas; apply the document variables to the document; generate one or more new documents, wherein the new documents each contain at least one of the document variables; and transmit, upon applying the document variables to the document, the new documents to one or more recipients.

In some aspects, the techniques described herein relate to a method for identifying the source of document leaks, the method including the steps of: receiving, by a processor, a document; identifying, by the processor, one or more changeable areas in the document; generating, by a predictive model, one or more document variables wherein the document variable include at least one or more changes in the document in the changeable areas; applying, by the processor, the document variables to the document; generating, by the processor, a new document, wherein the new document contains the document variables; and transmitting, by the processor, upon applying the document variables to the document, the document to one or more recipients.

In some aspects, the techniques described herein relate to a non-transitory computer readable medium containing computer executable instructions that, when executed by a wearable device including a processor, configure the computer hardware arrangement to perform procedures including: receiving a document; identifying one or more changeable areas in the document; generating one or more document variables wherein the document variable include at least one or more changes in the document in the changeable areas, wherein the one or more document variables do not change significantly the meaning of the document; applying the document variables to the document; generating a new document, wherein the new document contains the document variables; and transmitting upon applying the document variables to the document, the document to one or more recipients. Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a system according to an exemplary embodiment.

FIGS. 2A-2C are method diagrams illustrating document tracing.

FIGS. 3A-3B are diagram illustrating document maps according to exemplary embodiments.

FIG. 4 is a method diagram illustrating a process according to an exemplary embodiments.

FIG. 5 is a method diagram illustrating a process according to an exemplary embodiments.

FIG. 6 is a method diagram illustrating a process according to an exemplary embodiments.

FIG. 7 is a method diagram illustrating a process according to an exemplary embodiments.

FIG. 8 is a method diagram illustrating a process according to an exemplary embodiments.

FIG. 9 is a diagram illustrating a neural network according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment and that the specific features or advantages of an embodiment can be interchangeably combined with the specific features and advantages of any other embodiment. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention relates generally to systems and methods for tracking sensitive documents. Thus, the present application provides a technological solution: documents are modified such that tracking the documents can be performed by looking at the document itself rather than metadata or some tracking software. For example, suppose that a sensitive document is being sent to three separate authorized users. The present application can use natural language processing (NLP) to generally slightly different words, phrases, or document properties for each recipient. Thus, each recipient receives their own unique document. If any of the unique documents is lost, leaked, or accidently shared, the source of the leak can be determined by the content of leaked document itself. If a particular recipient received document A, and document A was leaked, then one can conclude that the particular recipient was responsible for the leak, at least to some degree if not entirely. Thus, the source of the leak can be determined with relative ease and efficiency. Also, this can be accomplished without requiring the use of metadata, which can be removed. In some embodiments, other approaches may be used to generate words, phrases, and document properties: For example, generative models like variational autoencoders or generative adversarial networks can be trained on a corpus of text to learn patterns and generate variations of words or phrases.

The present application improves upon conventional systems that verify documents through some other means such as metadata or encryption. Tracking the document is not made obvious because the tracking of the document is based on the literal content of the document. Thus, it is difficult to determine whether any one document is under surveillance. The systems and methods of the present application are configured to find elements of a document that are changeable and hardly noticeable. For example, the system and analyze a document and conclude that changing or deleting a certain word-change “Dear Recipient” to “Hello Recipient”-would not be noticeable to the typical user. As another example, the system can conclude that changing the spacing of the document from 2.0 spacing to 2.2 spacing would be unnoticeable. These and many other types of document changes are designed to go unnoticed by the user but easily noticed by a processor configured to analyze, generate, store, and re-analyze such changes.

Systems and methods of the present application provide numerous advantages. The systems enable a processor, e.g. through NLP, to analyze a document and find areas where small, unnoticeable changes can be made. This eliminates the need for tracking metadata which can be easily manipulated or even deleted with widely available software. Thus, the sharing of documents is made more private, more secure, and more easily traceable. Furthermore, the system generates a document map which contains all the information related to the form and content of the document. This document map can be changed and updated any number of times, thus ensuring that no single document can be duplicated or replicated without detection.

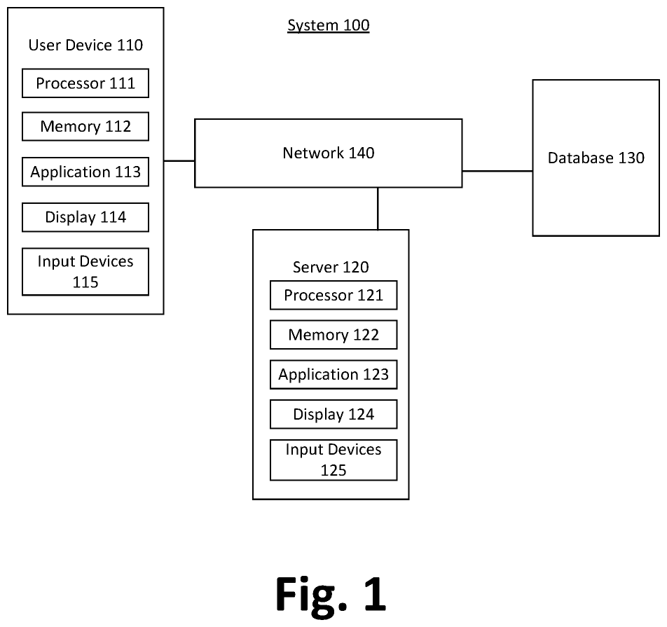

FIG. 1 illustrates a system 100 according to an exemplary embodiment. The system 100 may comprise a user device 110, a server 120, a database 130, and a network 140. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that, for example, enable network communications with one or more components of the system 100, transmit and/or receive data, and perform the functions described herein. Upon execution by the processor 111, the application 113 may perform the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The server 120 can be onsite, offsite, standalone, networked, online, or offline.

The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that, for example, enable network communications with one or more components of the system 100, transmit and/or receive data, and perform the functions described herein. Upon execution by the processor 121, the application 123 may perform the functions described in this specification, specifically to execute and perform the steps and functions in the process flows described below. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the payment information processor 130 that is available and supported by the payment information processor 130, such as a touch-screen, keyboard, mouse, cursor-control device, touch-screen, microphone, digital camera, video recorder or camcorder. These devices may be used to enter information and interact with the software and other devices described herein.

System 100 may include a database 130. The database 130 may be one or more databases configured to store data, including without limitation, private data of users, financial accounts of users, identities of users, transactions of users, and certified and uncertified documents. The database 130 may comprise a relational database, a non-relational database, or other database implementations, and any combination thereof, including a plurality of relational databases and non-relational databases. In some examples, the database 130 may comprise a desktop database, a mobile database, or an in-memory database. Further, the database 130 may be hosted internally by the server 120 or may be hosted externally of the server 120, such as by a server, by a cloud-based platform, or in any storage device that is in data communication with the server 160.

System 100 may include one or more networks 140. In some examples, the network 140 may be one or more of a wireless network, a wired network or any combination of wireless network and wired network, and may be configured to connect the user device 110, the server 120, and the database 130. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

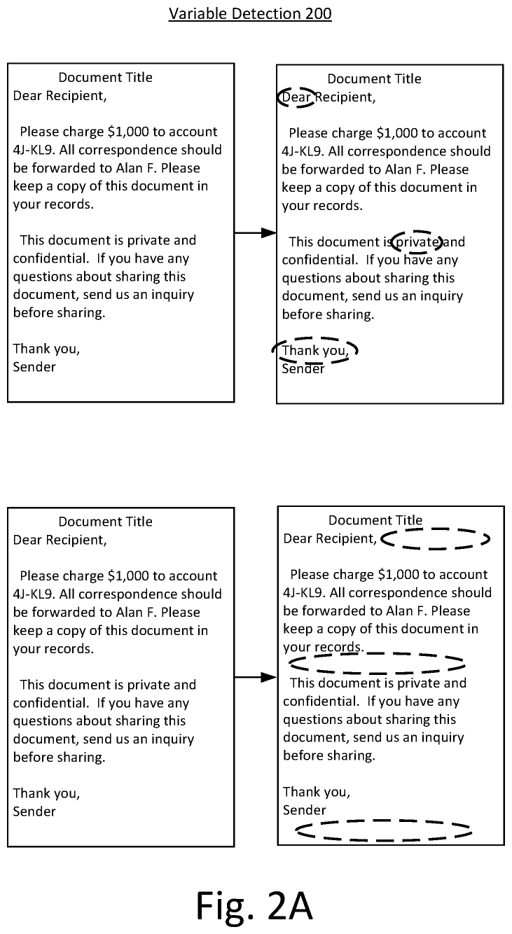

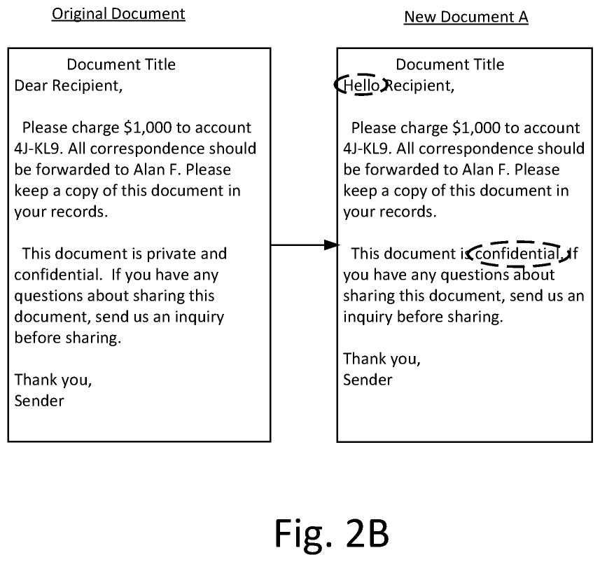

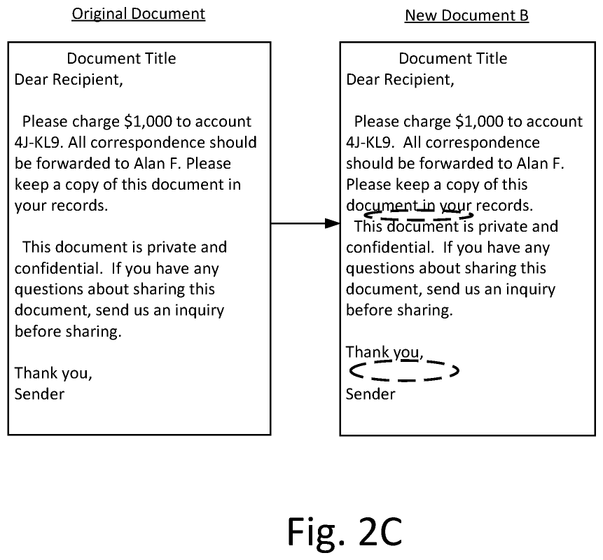

FIG. 2A illustrates how a processor can detect one or more changeable areas in one or more documents. As a nonlimiting example, a document may contain sensitive information. The document in FIG. 2A is sent from a sender to a recipient, and is requesting recipient to charge $1,000 to the account known as 4J-KL9. This is an example of document with sensitive information that if leaked would jeopardize the privacy of the sender and/or a third party. Despite the sensitivity, the document may have to be shared with multiple parties. For example, the document may need to be reviewed and approved by editors, reviewers, or superiors. Although the document in FIG. 2A is only one page, it is understood that the systems and methods described herein can be applied to documents of any length, from less than one page to many thousands of pages. The systems and methods can also be applied to documents of many different content, including words, numbers, and symbols arranged in letters, balance sheets, booklets, emails, and other related documents.

To protect the privacy of the document, conventional methods use metadata to track the chain of custody for a document. The metadata can track who has opened, edited, and even sent any document. However, metadata is easily removed through even the most conventional applications like Microsoft Word®. Thus, a much better way to track a document, establish a chain of custody, and proactively track document leaks would be to change discreet elements of the document that when observed will reveal who caused the leak. For example, the document in FIG. 2A may be sent to three different reviewers: reviewer A, reviewer B, and reviewer C. But each reviewer will receive slightly different versions of the document that has been altered through either form or content. Reviewer A will receive version A, reviewer B will receive version B, and reviewer C will receive version C. Each version will be different from one another. Thus, if version B is leaked, then it can be easily concluded that at least reviewer B was responsible.

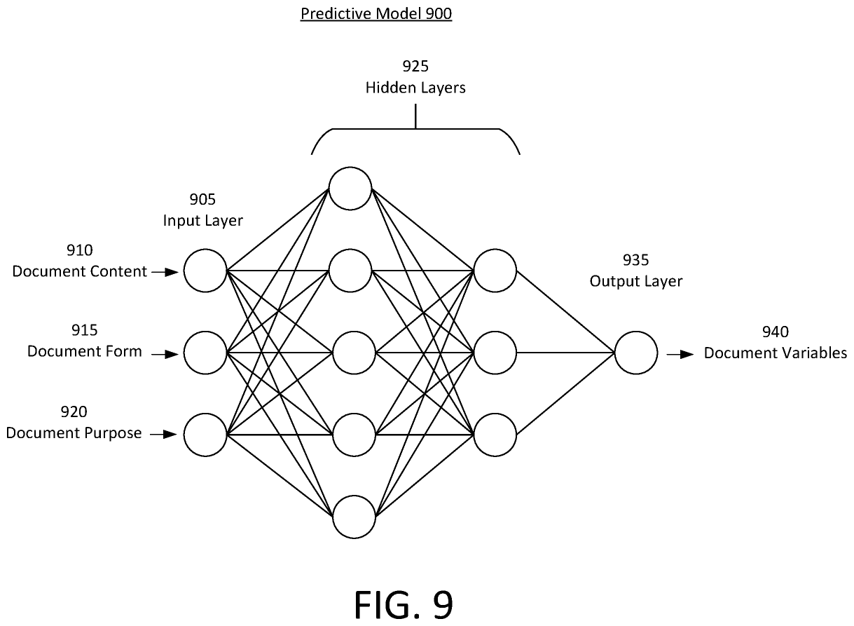

To create different versions of the same document, it is important to make changes that do not materially alter the meaning of the document. It is also important to make changes that are not easily noticeable to the human eye such that a nefarious party might notice the difference between version B and version C. Thus, the systems and methods described herein can find one or more points within a document that can be changed without changing the meaning of the document and without being noticeable to the human eye. In FIG. 2A, a document is analyzed by a processor. The processor can be associated with a user device, a server, a cloud server, a merchant processor, or some other processor discussed with further reference to FIG. 1. The processor can also be associated with a predictive model, machine learning model, or neural network as described with further reference to FIGS. 9-10. The processor can identify one or more changeable areas in the document. This action can be performed by or in connection with a natural language processor configured to scan the document and find one or more words, areas, or other elements of the document that can be changed without materially changing the document or being too noticeable to the human eye. In identifying the document the processor can without limitation: break up a sentence, number, or text into individual words or phrases, which can be tokens; label each token with its part of speech (e.g. noun, verb, adjective) to help the computer understand the grammatical structure of the sentence; analyze the grammatical structure of a sentence to identify the relationships between words and phrases; identify entities in a text, such as people, places, and organizations; analyze the emotional tone of a text, to determine whether it is positive, negative, or neutral; and/or use one or more machine learning algorithms to analyze language data and learn from it. This involves training the computer on large datasets of text, so that it can improve its ability to understand and generate text.

As a nonlimiting example, in FIG. 2A the processor can determine that the words “Dear,” “private,” and “Thank you” are changeable. In another example, the white space or empty space in between paragraphs, after a line, or at the end of a document are changeable and unnoticeable. In FIG. 2B, the processor can change “Dear Recipient” to “Hello Recipient,” and can change “private and confidential” to simply “confidential.” This is an example of the processor changing one or more words in the document into a new document A. In FIG. 2C, empty space between the first paragraph and the second paragraph has been decreased, and the empty space between “Thank you” and “Sender” has been increased. Although FIGS. 2B-2C describe only a changing of words and white space, it is understood that other elements of the document can be changed. Without limitation the changes can be applied to the following: watermarks; font sizes; font colors; font styles; margin sizes; page numbers; size and arrangement of symbols; additional text colored white or the same color as the background; watermark; line spacing; spacing between paragraphs; hyphenation; justification; and/or punctuation. In other embodiments, some combination of these examples can be used. For example, the processor can record how many words or letters overlap with a watermark.

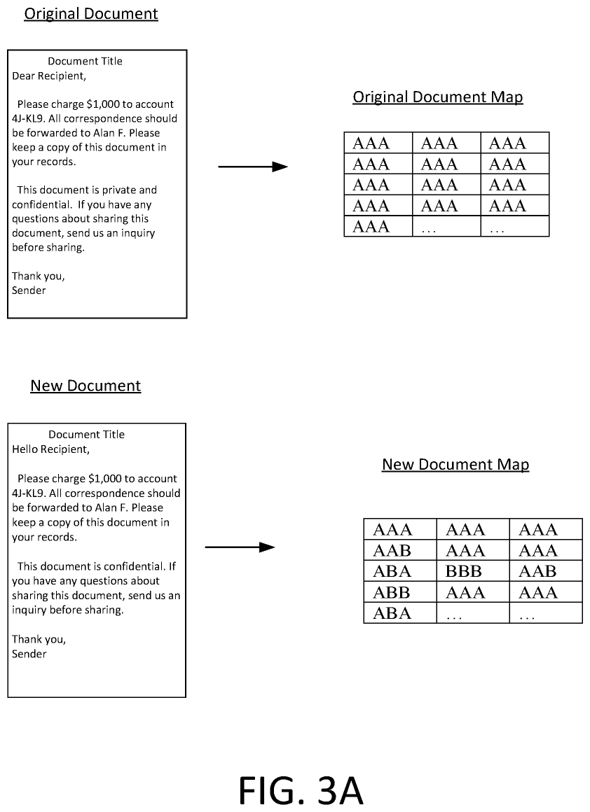

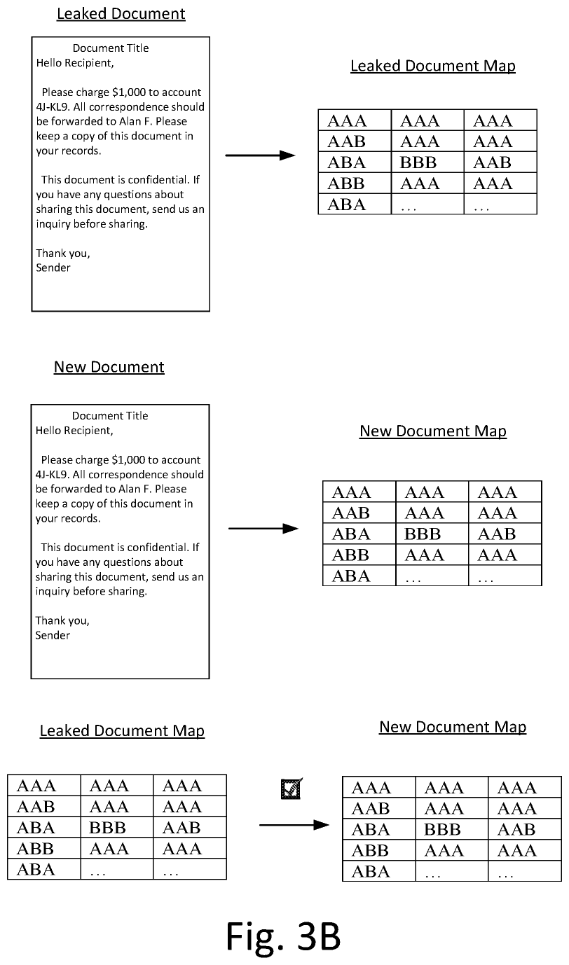

FIG. 3A illustrates how a document map can be made of each document and subsequent document version. To keep track of every document's change, a map can be made which indicates which parts of the document have been changed or which variables have been added to the document. Thus, the map acts as a record of how each new document differs from the original document. Each map associated with each version of the document can be used to verify changes to the document, update the records of each document, and track down which version of the document might be leaked. The map of the document is understood to be some organized table of data that represents changes implemented on the document. Thus, FIG. 3A shows how the original document—that is, the document without any changes or variables—has a standard document map. For example, the original document map may have AAA, AAA, AAA . . . for every cell wherein AAA signifies that nothing has been changed about a particular area of the document. The document map of a changed document—that is, the original document that has been changed in some way—can have a map ABA, BBB, AAB . . . wherein B signifies that some change has been made. The exact meaning of ABA or BBB can be defined by some template or rule. For example, BBB can mean that a word, font, and spacing has been changed for a particular area of the document. In other embodiments, other letters can be used such as ACA, ABD, etc. Although FIG. 3A depicts only a small number of rows and columns in the map, it is understood that in other embodiments the map can contain many more rows and columns, e.g. several thousands cells. It is understood that each cell corresponds to some element of the document, including without limitation a certain word; phrase; sentence; line; page; formatting; spacing; watermarks; font sizes; font colors; font styles; margin sizes; page numbers; size and arrangement of symbols; additional text colored white or the same color as the background; watermark; line spacing; spacing between paragraphs; hyphenation; justification; and/or punctuation. When the processor generates and applies one or more variables to the original document, a new document is created, and a corresponding new document map can be created. The new document map can indicate where and how the new document differs from the original document, including what variables have been added. The document map can be stored, retrieved, updated, and re-stored any number of times. The updates to the document map can be made manually by a user or automatically by a processor or machine learning model.

FIG. 3B illustrates how document can be verified or otherwise checked against a leaked document or any version of a document. For example, suppose that a certain document has been leaked. The leaked document contains any number of variables applied by the predictive model discussed elsewhere herein. Have obtained the leaked document, the processor can analyze the leaked document and create a document map associated with the leaked document. In some embodiments, the processor can work backwards from the content and form of the document to create the document map. In other embodiments, the processor can find the original document associated with the leaked document, then find other versions of the new document, analyze each of the original document's map and the other new documents' maps, and recreate the leaked document map from those pre-existing maps. The processor may retrieve and store each map any number of times. After generating the leaked document map, the processor can compare the leaked document map to one or more of the new document maps. The processor can retrieve any one of the one or more document maps from a data storage unit or database. Upon determining which new document map matches or most closely matches the leaked document map, the processor can determine the source of the leaked document.

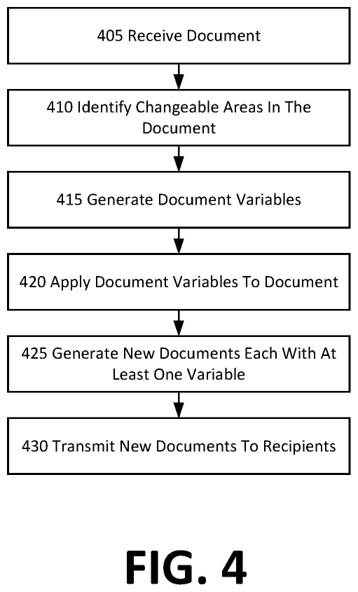

FIG. 4 illustrates a method for generating variables, applying those variables to a document, generating new documents, and sending those new documents out to one or more receivers. The receivers can include one or more devices suitable for receiving documents in a digital format such as a server, a network appliance, a personal computer, a workstation, a phone, a handheld personal computer, a personal digital assistant, a thin client, a fat client, an Internet browser, a mobile device, a kiosk, or some other computer device or communications device. The processor can be associated with a user device, a server, a cloud server, a merchant processor, or some other processor with further reference to FIG. 1. In action 405, the processor can receive or retrieve a document. The document can be any kind of document, including without limitation including words, numbers, and symbols arranged in letters, balance sheets, booklets, emails, and other related documents. In action 410, the processor can identify one or more changeable areas in the document. That is, the processor can find one or more points within a document that can be changed without changing the meaning of the document and without being easily noticeable to the human eye. This action can be performed by or in connection with a natural language processor configured to scan the document and find one or more words, areas, or other elements of the document that can be changed without materially changing the document or being too noticeable to the human eye. In identifying the document the processor can without limitation: break up a sentence, number, or text into individual words or phrases, which can be tokens; label each token with its part of speech (e.g. noun, verb, adjective) to help the computer understand the grammatical structure of the sentence; analyze the grammatical structure of a sentence to identify the relationships between words and phrases; identify entities in a text, such as people, places, and organizations; analyze the emotional tone of a text, to determine whether it is positive, negative, or neutral; and/or use one or more machine learning algorithms to analyze language data and learn from it. This involves training the computer on large datasets of text, so that it can improve its ability to understand and generate text. Furthermore, the processor can define a changeable area by what is selected by a user.

In action 415, the processor can generate one or more document variables. Each of the one or more variables can be expressed as a change in some form or content of the original document, whether visible to the human eye or not. Without limitation the changes can be applied to the following: watermarks; font sizes; font colors; font styles; margin sizes; page numbers; size and arrangement of symbols; additional text colored white or the same color as the background; watermark; line spacing; spacing between paragraphs; hyphenation; justification; and/or punctuation. In some embodiments, the one or more document variables comprise a new numerical or alphanumeric symbol replacing an original numerical or alphanumerical symbol in the document. In other embodiments, some combination of these examples can be used. Each document variable can be analyzed and/or generated by the processor as well as a machine learning model, predictive model, or neural network described with further reference to FIGS. 9 and 10. Having generated one or more document variables, in action 420 the processor can apply the document variables to the document. In action 425, the processor can generate one or more new documents wherein each new document has at least one of the document variables. Having generated one or more new documents, in action 430 the processor can transmit the new documents to their intended recipients. In some embodiments, only one new document will be submitted to an individual recipient or group of recipients.

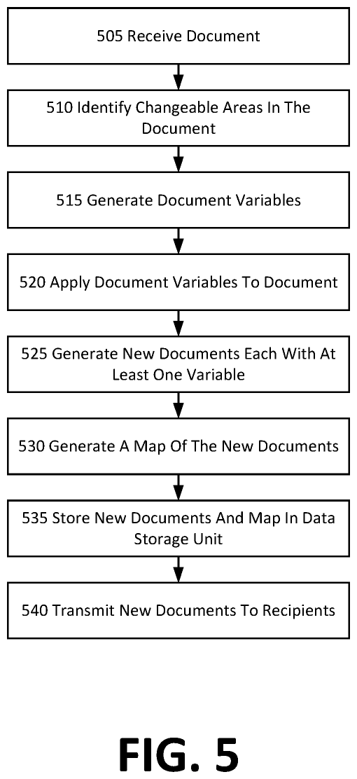

FIG. 5 illustrates a method for generating a document map of a document with variables. The processor can be associated with a user device, a server, a cloud server, a merchant processor, or some other processor with further reference to FIG. 1. In action 505, the processor can receive or retrieve a document. The document can be any kind of document, including without limitation including words, numbers, and symbols arranged in letters, balance sheets, booklets, emails, and other related documents. In action 510, the processor can identify one or more changeable areas in the document. That is, the processor can find one or more points within a document that can be changed without changing the meaning of the document and without being easily noticeable to the human eye. This action can be performed by or in connection with a natural language processor configured to scan the document and find one or more words, areas, or other elements of the document that can be changed without materially changing the document or being too noticeable to the human eye. In identifying the document the processor can without limitation: break up a sentence, number, or text into individual words or phrases, which can be tokens; label each token with its part of speech (e.g. noun, verb, adjective) to help the computer understand the grammatical structure of the sentence; analyze the grammatical structure of a sentence to identify the relationships between words and phrases; identify entities in a text, such as people, places, and organizations; analyze the emotional tone of a text, to determine whether it is positive, negative, or neutral; and/or use one or more machine learning algorithms to analyze language data and learn from it. This involves training the computer on large datasets of text, so that it can improve its ability to understand and generate text. Furthermore, the processor can define a changeable area by what is selected by a user.

In action 515, the processor can generate one or more document variables. Each of the one or more variables can be expressed as a change in some form or content of the original document, whether noticeable to the human eye or not. Without limitation the changes can be applied to the following: watermarks; font sizes; font colors; font styles; margin sizes; page numbers; size and arrangement of symbols; additional text colored white or the same color as the background; watermark; line spacing; spacing between paragraphs; hyphenation; justification; and/or punctuation. In other embodiments, some combination of these examples can be used. In some embodiments, the one or more document variables comprise a new numerical or alphanumeric symbol replacing an original numerical or alphanumerical symbol in the document. Each document variable can be analyzed and/or generated by the processor as well as a machine learning model, predictive model, or neural network described with further reference to FIGS. 9 and 10. Having generated one or more document variables, in action 520 the processor can apply the document variables to the document. In action 525, the processor can generate one or more new documents wherein each new document has at least one of the document variables. Having generated the new documents, the processor can generate a map of each of the new documents in action 530. Mapping the new documents and original document are discussed with further reference to FIGS. 3A-3B. In action 535, the processor can store each of the document maps, both original and new, in a data storage unit or database for long term storage and/or later use. In action 540, the processor can transmit the new documents to their intended recipients. In some embodiments, only one new document will be submitted to an individual recipient or group of recipients.

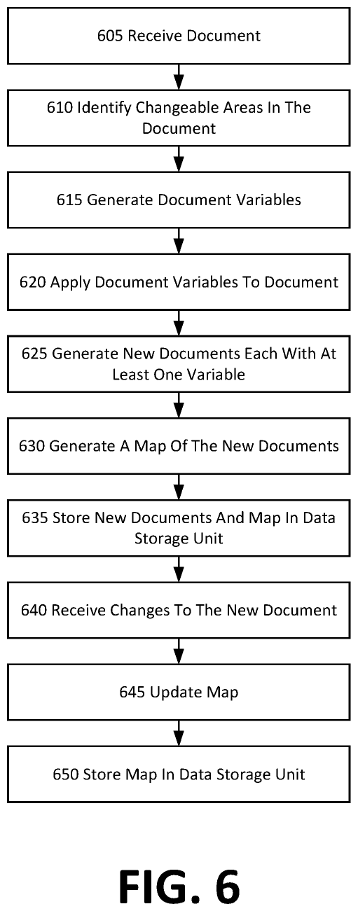

FIG. 6 describes a method for updating a document map. The processor can be associated with a user device, a server, a cloud server, a merchant processor, or some other processor with further reference to FIG. 1. In action 605, the processor can receive or retrieve a document. The document can be any kind of document, including without limitation including words, numbers, and symbols arranged in letters, balance sheets, booklets, emails, and other related documents. In action 610, the processor can identify one or more changeable areas in the document. That is, the processor can find one or more points within a document that can be changed without changing the meaning of the document and without being easily noticeable to the human eye. This action can be performed by or in connection with a natural language processor configured to scan the document and find one or more words, areas, or other elements of the document that can be changed without materially changing the document or being too noticeable to the human eye. In identifying the document the processor can without limitation: break up a sentence, number, or text into individual words or phrases, which can be tokens; label each token with its part of speech (e.g. noun, verb, adjective) to help the computer understand the grammatical structure of the sentence; analyze the grammatical structure of a sentence to identify the relationships between words and phrases; identify entities in a text, such as people, places, and organizations; analyze the emotional tone of a text, to determine whether it is positive, negative, or neutral; and/or use one or more machine learning algorithms to analyze language data and learn from it. This involves training the computer on large datasets of text, so that it can improve its ability to understand and generate text. Furthermore, the processor can define a changeable area by what is selected by a user.

In action 615, the processor can generate one or more document variables. Each of the one or more variables can be expressed as a change in some form or content of the original document, whether noticeable to the human eye or not. Without limitation the changes can be applied to the following: watermarks; font sizes; font colors; font styles; margin sizes; page numbers; size and arrangement of symbols; additional text colored white or the same color as the background; watermark; line spacing; spacing between paragraphs; hyphenation; justification; and/or punctuation. In other embodiments, some combination of these examples can be used. Each document variable can be analyzed and/or generated by the processor as well as a machine learning model, predictive model, or neural network described with further reference to FIGS. 9 and 10. Having generated one or more document variables, in action 620 the processor can apply the document variables to the document. In action 625, the processor can generate one or more new documents wherein each new document has at least one of the document variables. Having generated the new documents, the processor can generate a map of each of the new documents in action 630. Mapping the new documents and original document are discussed with further reference to FIGS. 3A-3B. In action 635, the processor can store each of the document maps, both original and new, in a data storage unit or database for long term storage and/or later use. In action 640, the processor can receive one or more changes to one or more of the new documents. The change can include any edits or changes to the document as described in actions 610-635 and elsewhere. The changes may be manual changes or automatic changes to the document. Having received the changes, in action 645 the processor can update the one or more maps associated with the change. In action 650, the processor can store the map in the data storage unit or database for long term storage and/or later use.

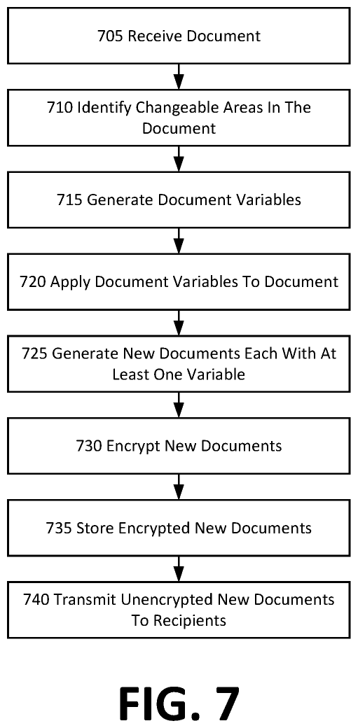

FIG. 7 illustrates a method for encrypted a new document with variables. The processor can be associated with a user device, a server, a cloud server, a merchant processor, or some other processor with further reference to FIG. 1. In action 705, the processor can receive or retrieve a document. The document can be any kind of document, including without limitation including words, numbers, and symbols arranged in letters, balance sheets, booklets, emails, and other related documents. In action 710, the processor can identify one or more changeable areas in the document. That is, the processor can find one or more points within a document that can be changed without changing the meaning of the document and without being easily noticeable to the human eye. This action can be performed by or in connection with a natural language processor configured to scan the document and find one or more words, areas, or other elements of the document that can be changed without materially changing the document or being too noticeable to the human eye. In identifying the document the processor can without limitation: break up a sentence, number, or text into individual words or phrases, which can be tokens; label each token with its part of speech (e.g. noun, verb, adjective) to help the computer understand the grammatical structure of the sentence; analyze the grammatical structure of a sentence to identify the relationships between words and phrases; identify entities in a text, such as people, places, and organizations; analyze the emotional tone of a text, to determine whether it is positive, negative, or neutral; and/or use one or more machine learning algorithms to analyze language data and learn from it. This involves training the computer on large datasets of text, so that it can improve its ability to understand and generate text. Furthermore, the processor can define a changeable area by what is selected by a user.

In action 715, the processor can generate one or more document variables. Each of the one or more variables can be expressed as a change in some form or content of the original document, whether visible to the human eye or not. Without limitation the changes can be applied to the following: watermarks; font sizes; font colors; font styles; margin sizes; page numbers; size and arrangement of symbols; additional text colored white or the same color as the background; watermark; line spacing; spacing between paragraphs; hyphenation; justification; and/or punctuation. In other embodiments, some combination of these examples can be used. Each document variable can be analyzed and/or generated by the processor as well as a machine learning model, predictive model, or neural network described with further reference to FIGS. 9 and 10. Having generated one or more document variables, in action 720 the processor can apply the document variables to the document. In action 725, the processor can generate one or more new documents wherein each new document has at least one of the document variables. In action 730, the processor can encrypt one or more of the new documents. The encryption can any encryption known in the art, including without limitation asymmetric encryption, symmetric encryption, cloud-based encryption, or any encryption utilizing public key infrastructure. The method can further include encrypting the document maps. Having encrypted the documents, in action 735 the processor can store the encrypted documents in a data storage unit or database for long-term storage and/or later use. In action 740, the processor can transmit the unencrypted new documents to the recipients. In some embodiments, the processor can transmit the encrypted documents to the recipients at which point the recipients may decrypt the documents with the appropriate key or authentication factor.

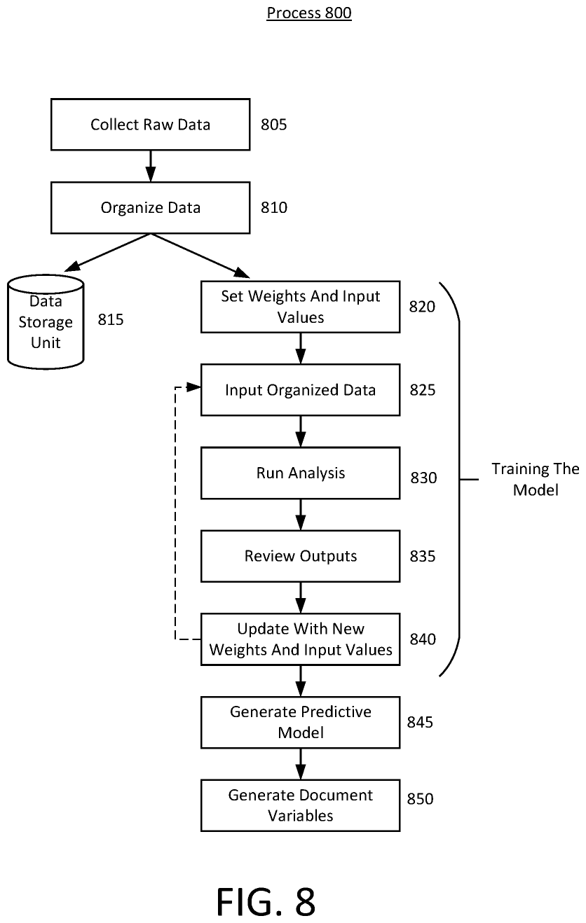

FIG. 8 is a flowchart illustrating the generation of a predictive model and the generating of one or more document variables.

The process 800 describes the training process for an exemplary predictive model or neural network suitable for predicting and generating of one or more document variables. The process can begin with action 805 when raw data is collected. The raw data can be associated with the document, the sender, the recipient, and the purpose of document. The information can further include watermarks; font sizes; font colors; font styles; margin sizes; page numbers; size and arrangement of symbols; additional text colored white or the same color as the background; watermark; line spacing; spacing between paragraphs; hyphenation; justification; and/or punctuation. The collection of raw data can be performed by a processor or application associated with the user device or server. The raw data can be transmitted over a wired or wireless network. The data may have been previously gathered and stored in a database or data storage unit in which case the processor or application can retrieve the data from the data storage unit. In some embodiments, the raw data can be received by feeding the documents through a processor configured to scan, read, or otherwise collect the data contained in the document as well as the document maps discussed with further reference to FIGS. 3A and 3B. The raw data can be received continuously or in batches. The raw data can be updated at any time. At action 810, the processor or application can organize the raw data into discernable categories including but not limited to document form, document content, chain of custody, and purpose of the document. The categories can be predetermined by the user or created by the predictive model. At action 815, the organized or raw data can be transmitted to the data storage unit. The data storage unit can be associated with the user device or server. The raw or organized data can be transmitted over a wired network, wireless network, or one or more express buses. Upon organizing the data into one or categories, the processor or application can proceed with training the predictive model in actions 820 through 840. The training portion can have any number of iterations. The predictive model can comprise one or more neural networks described with further reference to FIG. 9.

The training portion can begin with action 820 when the weights and input values are set by the user or by the model itself. Furthermore, the weights can be the predetermined connections between the inputs and the hidden layers described with further reference to FIG. 9. The input values are the values that are fed into the neural network. The input values may be discerned by the different categories created in action 810, although other distinct input values may be discerned. The inputs can include without limitation historical information related to the document, changes and variables generated for the document, and other information associated with the document such as chain of custody, manual changes or variables applied to the document, known leaks of the documents, editing history, and other information. In action 825, the data in inputted in the neural network, and in action 830 the neural network analyzes the data according to the weights and other parameters set by the user. As a nonlimiting, example, the user may create the stipulation that no document can have more than 25 variables on each page of the document. In action 835, the outputs are reviewed. The outputs can include one or more document variables that are suitable for any one document, or any relevant output determined by the user. In action 840, the predictive model may be updated with new data and parameters. The new data can be collected by the processor in a similar fashion to actions 805 and 810. Though it is not necessary in this exemplary embodiment to retrain the predictive model, the predictive model can be re-trained any number times such that actions 825 through 840 are repeated until a satisfactory output is achieved or some other parameter has been met. As a nonlimiting example, the user may update the inputs with new changeable areas. As another nonlimiting example, the user can adjust the weighted relationship between the input layer and the one or more hidden layers of a neural network discussed with further reference to FIG. 9. If a satisfactory output has been recorded, then in action 845 one or more predictive models can be generated. It is understood that the predictive model, once generated, can undergo further training like actions 820 to 845. Having generated the predictive model, in action 850 the model can generate one or more document variables given the unique input values collected from a particular document and its intended recipients.

FIG. 9 is a diagram illustrating a neural network as an exemplary embodiment for the predictive model.

A neural network is a series of algorithms that can, under predetermined training restrictions, recognize relationships between one or more variables. A neuron in a neural network is a mathematical function that collects and classifies information according to a specific form set by a user. A neural network can be divided into three main components: an input layer, a processing or hidden layer, and an output layer. The input layer comprises data sets chosen to be inserted into the neural network for analysis. The hidden layers include one or more neurons that can classify the inputs according to parameters set by the user. The hidden layers can comprise multiple successive layers, the first layer positioned immediately after the input layer and the last layer positioned immediately before the output layer. The hidden layer immediately after the input layer may be connected to the input layer via a predetermined weight or emphasis. These weights can be assigned according to the modeler's agenda. Alternatively, the model itself can determine the optimal weights between layers such that a predetermined outcome, margin of error, or minimum data point is achieved.

The predictive model can comprise a neural network 900. The neural network may be integrated into the server, the user device, or some other computer device suitable for neural network analysis. The sever can be associated with the software application. The neural network can include an input layer 905, one or more hidden layers 925, and an output layer 935. Although only a certain number of nodes are depicted in FIG. 9, it is understood that the neural network according to the disclosed embodiments may include less or more nodes in each layer. Additionally, the hidden layers can include more or less layers than what is depicted in FIG. 9. It is also understood that the connections between each layer may be assigned a predetermined weight according to user's manual change or according to some weight value generated by the neural network itself. The input layer may include sets of data gathered from outside sources. The neural network can include document content 910, document form 915, and document purpose 920 that is interacting with the card. Other inputs not depicted in FIG. 9 can include watermarks; font sizes; font colors; font styles; margin sizes; page numbers; size and arrangement of symbols; additional text colored white or the same color as the background; watermark; line spacing; spacing between paragraphs; hyphenation; justification; and punctuation. Upon analyzing the inputs via the one or more hidden layers, the neural network can create one or more document variables 940. It is understood that one or more neural networks or some combination of neural networks can be trained according to individual users. It is understood that any of the neural networks described herein may be trained or iterated any number of times. In some embodiments, the neural network can be re-trained and/or updated after every recordation of new document content, form, and purpose. In still other embodiments, the neural network can be trained until a sufficient level of accuracy has been reached. The neural networks can be trained to arrive at any number of conclusions, including: whether the document variables are compatible with the user-specified changes in the document; and whether there is a third party noticing a likelihood of each variable.

In some embodiments, the application can analyze document information using a predictive model including without limitation a recursive neural network (RNN), convolutional neural network (CNN), artificial neural network (ANN), or some other neural network. The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as CNNs or RNNs, to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

In some aspects, the techniques described herein relate to a system for identifying the source of document leaks, the system including: a processor configured to: receive a document; identify one or more changeable areas in the document; generate, by a predictive model, one or more document variables wherein the document variable include at least one or more changes in the document in the changeable areas; apply the document variables to the document; generate one or more new documents, wherein the new documents each contain at least one of the document variables; and transmit, upon applying the document variables to the document, the new documents to one or more recipients.

In some aspects, the techniques described herein relate to a system, wherein the processor is further to store, upon applying the document variables to the document, the document in a data storage unit.

In some aspects, the techniques described herein relate to a system, wherein each of the new documents do not share the same set of document variables.

In some aspects, the techniques described herein relate to a system, wherein the processor is further configured to transmit each of the new documents to the recipients, wherein each of the recipients receives only one of the new documents.

In some aspects, the techniques described herein relate to a system, wherein the processor is further configured to generate a map of the document, wherein the map describes form and content associated with the new document and document variables.

In some aspects, the techniques described herein relate to a system, wherein the map further includes the recipients who received the new document.

In some aspects, the techniques described herein relate to a system, wherein the one or more document variables include a new word replacing an original word in the document.

In some aspects, the techniques described herein relate to a system, wherein the one or more document variables include a new phrase replacing an original phrase in the document.

In some aspects, the techniques described herein relate to a system, wherein the one or more document variables include a new numerical or alphanumeric symbol replacing an original numerical or alphanumerical symbol in the document.

In some aspects, the techniques described herein relate to a system, wherein the one or more document variables include a new form or style of the document replacing an original form or style of the document.

In some aspects, the techniques described herein relate to a method for identifying the source of document leaks, the method including the steps of: receiving, by a processor, a document; identifying, by the processor, one or more changeable areas in the document; generating, by a predictive model, one or more document variables wherein the document variable include at least one or more changes in the document in the changeable areas; applying, by the processor, the document variables to the document; generating, by the processor, a new document, wherein the new document contains the document variables; and transmitting, by the processor, upon applying the document variables to the document, the document to one or more recipients.

In some aspects, the techniques described herein relate to a method, wherein the steps further include generating a map of the document, wherein the map describes form and content associated with the new document.

In some aspects, the techniques described herein relate to a method, wherein the steps further include: receiving, by the processor, one or more changes to the document; updating, by the processor, the map of the document; and storing, by the processor, the map of the document in a data storage unit.

In some aspects, the techniques described herein relate to a method, wherein the steps further include tracking, by the processor, one or more metadata of the new document.

In some aspects, the techniques described herein relate to a method, wherein the steps further include identifying, by the processor, one or more non-changeable areas in the document.

In some aspects, the techniques described herein relate to a method, wherein the steps further include applying, by the processor, a document variable created manually by a user.

In some aspects, the techniques described herein relate to a method, wherein the steps further include: encrypting the new document; and storing the encrypted new document in a data storage unit.

In some aspects, the techniques described herein relate to a method, wherein the steps further include: receiving, by the processor, one or more changes to the document; updating, by the processor, the predictive model with the changes; and monitoring the new document for further changes.

In some aspects, the techniques described herein relate to a method, wherein the steps further include identifying, by the processor, which of the one or more changeable areas in the document would be, if given a change, the least likely to be noticed by a user.

In some aspects, the techniques described herein relate to a non-transitory computer readable medium containing computer executable instructions that, when executed by a wearable device including a processor, configure the computer hardware arrangement to perform procedures including: receiving a document; identifying one or more changeable areas in the document; generating one or more document variables wherein the document variables include at least one or more changes in the document in the changeable areas, wherein the one or more document variables do not change significantly the meaning of the document; applying the document variables to the document; generating a new document, wherein the new document contains the document variables; and transmitting upon applying the document variables to the document, the document to one or more recipients.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system for identifying a source of document leaks, the system comprising:
a processor configured to:
receive a document;
identify one or more changeable areas in the document;
generate, by a predictive model, one or more document variables wherein the document variable comprise at least one or more changes in the document in the changeable areas;
apply the document variables to the document;
generate one or more new documents, wherein the new documents each contain at least one of the document variables; and
transmit, upon applying the document variables to the document, the new documents to one or more recipients.

2. The system of claim 1, wherein the processor is further to store, upon applying the document variables to the document, the document in a data storage unit.

3. The system of claim 1, wherein each of the new documents do not share the same document variables.

4. The system of claim 1, wherein the processor is further configured to transmit each of the new documents to the recipients, wherein each of the recipients receives only one of the new documents.

5. The system of claim 1, wherein the processor is further configured to generate a map of the document, wherein the map describes form and content associated with the new document and document variables.

6. The system of claim 5, wherein the map further comprises the recipients who received the new document.

7. The system of claim 1, wherein the one or more document variables comprise a new word replacing an original word in the document.

8. The system of claim 1, wherein the one or more document variables comprise a new phrase replacing an original phrase in the document.

9. The system of claim 1, wherein the one or more document variables comprise a new numerical or alphanumeric symbol replacing an original numerical or alphanumerical symbol in the document.

10. The system of claim 1, wherein the one or more document variables comprise a new form or style of the document replacing an original form or style of the document.

11. A method for identifying a source of document leaks, the method comprising the steps of:
receiving, by a processor, a document;
identifying, by the processor, one or more changeable areas in the document;
generating, by a predictive model, one or more document variables wherein the document variable comprise at least one or more changes in the document in the changeable areas;
applying, by the processor, the document variables to the document;
generating, by the processor, a new document, wherein the new document contains the document variables; and
transmitting, by the processor, upon applying the document variables to the document, the document to one or more recipients.

12. The method of claim 11, wherein the steps further comprise generating a map of the document, wherein the map describes form and content associated with the new document.

13. The method of claim 12, wherein the steps further comprise:
receiving, by the processor, one or more changes to the document;
updating, by the processor, the map of the document; and
storing, by the processor, the map of the document in a data storage unit.

14. The method of claim 12, wherein the steps further comprise tracking, by the processor, one or more metadata of the new document.

15. The method of claim 11, wherein the steps further comprise identifying, by the processor, one or more non-changeable areas in the document.

16. The method of claim 11, wherein the steps further comprise applying, by the processor, a document variable created manually by a user.

17. The method of claim 11, wherein the steps further comprise:
encrypting the new document; and
storing the encrypted new document in a data storage unit.

18. The method of claim 11, wherein the steps further comprise:
receiving, by the processor, one or more changes to the document;
updating, by the processor, the predictive model with the changes; and
monitoring the new document for further changes.

19. The method of claim 11, wherein the steps further comprise identifying, by the processor, which of the one or more changeable areas in the document would be, if given a change, the least likely to be noticed by a user.

20. A non-transitory computer readable medium containing computer executable instructions that, when executed by a computer hardware arrangement comprising a processor, configure the computer hardware arrangement to perform procedures comprising:
receiving a document;
identifying one or more changeable areas in the document;
generating one or more document variables wherein the document variables comprise at least one or more changes in the document in the changeable areas, wherein the one or more document variables do not change significantly a meaning of the document;
applying the document variables to the document;
generating a new document, wherein the new document contains the document variables; and
transmitting upon applying the document variables to the document, the document to one or more recipients.
